(19) United States
(12) Patent Application Publication
(10) Pub. No.: US 2013/0110920 A1
(43) Pub. Date: May 2, 2013

(54) NETWORK-ASSISTED PEER-TO-PEER SECURE COMMUNICATION ESTABLISHMENT

(71) Applicants: Ioannis Broustis, Millburn, NJ (US); Ganapathy S. Sundaram, Hillsborough, NJ (US)

(72) Inventors: Ioannis Broustis, Millburn, NJ (US); Ganapathy S. Sundaram, Hillsborough, NJ (US)

(73) Assignee: Alcatel-Lucent USA Inc., Murray Hill, NJ (US)

(21) Appl. No.: 13/283,133

(22) Filed: Oct. 27, 2011

(51) Int. Cl. G06F 15/16

(52) U.S. Cl. 709/204

(57) ABSTRACT

Techniques are disclosed for establishing network-assisted secure communications in a peer-to-peer environment. For example, a method for secure communications comprises the following steps. A first computing device provides connectivity information associated therewith to a network server. The first computing device receives connectivity information respectively associated with one or more other computing devices from the network server. The first computing device, independent of the network server, establishes a security association with at least one of the one or more other computing devices. The first computing device, independent of the network server, participates in a secure peer-to-peer session with the at least one other computing device.

### FIELD OF THE INVENTION

The present invention relates generally to communication security and, more particularly, to techniques for establishing secure communications in a peer-to-peer environment.

### BACKGROUND OF THE INVENTION

Peer-to-peer (p2p) computing or networking is a distributed application architecture that partitions tasks or workloads among computing devices referred to as peers. The term “peer” typically denotes that computing devices so designated are substantially equivalent in functionality with respect to a given application.

However, like any computing device operating in a distributed architecture, it is realized that it is important to secure end-to-end communication exchanges between the peers.

### SUMMARY OF THE INVENTION

Embodiments of the invention provide techniques for establishing network-assisted secure communications in a peer-to-peer environment.

For example, in one embodiment of the invention, a method for secure communications comprises the following steps. A first computing device provides connectivity information associated therewith to a network server. The first computing device receives connectivity information respectively associated with one or more other computing devices from the network server. The first computing device, independent of the network server, establishes a security association with at least one of the one or more other computing devices. The first computing device, independent of the network server, participates in a secure peer-to-peer session with the at least one other computing device.

In another embodiment, a computing device comprises a memory and a processor device operatively coupled to the memory. The memory and processor device are configured to cause the computing device to: provide connectivity information associated with the computing device to a network server; receive from the network server connectivity information respectively associated with one or more other computing devices; establish, independent of the network server, a security association with at least one of the one or more other computing devices; and participate, independent of the network server, in a secure peer-to-peer session with the at least one other computing device.

In a further embodiment, a system comprises a communications module and a cryptography module operatively coupled to the communications module. The communications module and the cryptography module cooperate to perform the steps of: providing connectivity information to a network server; receiving from the network server connectivity information respectively associated with one or more computing devices; establishing, independent of the network server, a security association with at least one of the one or more computing devices; and participating, independent of the network server, in a secure peer-to-peer session with the at least one computing device.

Advantageously, techniques of the invention provide for network-assisted peer-to-peer secure communications.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1A illustrates a network-assisted peer-to-peer secure communication system, according to an embodiment of the invention.

FIG. 1B illustrates component modules of a peer, according to an embodiment of the invention.

FIG. 2 illustrates a communication protocol between a peer and a network server, according to an embodiment of the invention.

FIG. 3 illustrates a secure key exchange, according to an embodiment of the invention.

FIG. 4 illustrates operations of communication modules for communication between peers, according to an embodiment of the invention.

FIG. 5 illustrates operations of a cryptography module for preparing a first authenticated key exchange message, according to an embodiment of the invention.

FIG. 6 illustrates an alternative implementation of a cryptography module, according to an embodiment of the invention.

FIG. 7 illustrates operations of an initiator's cryptography module upon receiving a second identity based authenticated key exchange message, according to an embodiment of the invention.

FIG. 8 illustrates operations of a responder's cryptography module upon receiving a second identity based authenticated key exchange message, according to an embodiment of the invention.

FIG. 9 illustrates operations of a responder's cryptography module upon receiving a third authenticated key exchange message, according to an embodiment of the invention.

FIG. 10 illustrates a hardware architecture of a part of a communication system and computing devices suitable for implementing one or more of the methodologies and protocols according to one or more embodiments of the invention.

### DETAILED DESCRIPTION OF PREFERRED EMBODIMENTS

Embodiments of the invention will be described below in the context of illustrative mutual authentication and key exchange protocols. However, it is to be appreciated that embodiments of the invention are not limited to any particular mutual authentication and key exchange protocols. Rather, embodiments of the invention are applicable to any suitable communication environment where it would be desirable to provide network-assisted peer-to-peer secure communications.

The term “peer” as used herein is generally defined as a computing device that is substantially equivalent in functionality to another computing device (or peer). It is understood that each peer, as described herein, can also operate as a “client” or a “server” depending on whether the peer is an “initiator” (and thus a client) of a data session or a “responder” (and thus a server), as will be explained in further detail below. Thus, a given peer has the capabilities of operating as both a client and a server. Further, a “peer-to-peer relationship” as used herein is generally defined as the existence of a data or communication session between two or more peers (secure peer-to-peer session).

The phrase “network server” as used herein is generally defined as one or more computing devices (server devices) that are substantially under the control of an operator of a communication network (i.e., network operator), or an operator or a provider of an application or a service (i.e., an application or service provider/operator). Examples of such network operators may include but are not limited to AT&T™, Verizon™, NTT™, China Mobile™, and France Telecom/Orange™. Examples of such application providers may include but are not limited to Skype™, Google™, Yahoo™, and MSN™. By the phrase “substantially under the control of” an operator of a communication network or operator of a service, it is meant that the network operator maintains and/or manages functionality and operations of the network server, and in the case of the application or service provider/operator, the provider/operator maintains and/or manages functionality and operations of the network server.

Furthermore, when referring to a network server herein, it is to be understood that a network server may comprise a single server device or multiple server devices. The multiple server devices may be collocated or remote from one another. When the network server comprises multiple server devices, different ones of the multiple server devices may perform different operations with respect to the peers.

The term “key” as used herein is generally defined as an input to a cryptographic protocol, for purposes such as, but not limited to, entity authentication, privacy, message integrity, etc.

The phrase “security association” as used herein generally refers to a security definition in a communication environment across which two or more parties and/or devices communicate. In one example, the security definition may include, but is not limited to, a session key.

As will be described in detail below, illustrative embodiments of the invention provide methodologies for assisting the establishment of communications between computing devices operating as peers, wherein a peer is not apriori capable of reaching his fellow peer(s) due to a lack of connectivity information. In such a setting, as will be explained in further detail below, each peer securely contacts a network server in the network and registers and provides the network server its own connectivity information (e.g., its Internet Protocol (IP) address). The peer also requests connectivity information (e.g., IP addresses) for all other registered peers of interest, preferably in bulk. The obtained connectivity information is used by the peer towards securely contacting fellow peer(s) directly, i.e., without further assistance by the network and, more particularly, independent of the network server. It is to be appreciated that other forms of connectivity information may be employed other than IP addresses, e.g., link layer attributes is but one alternate example. In general, connectivity information may be any form of information that provides location information regarding a given computing device so that another computing device can connect (e.g., communicate in a data session) with the given computing device. The computing devices may be mobile (e.g., cellular phones, etc.) or fixed (e.g., gateways, etc.).

It is assumed that the computing devices are operating in an IP-enabled environment where registered peers are mutually reachable using IP address information or some other form of connectivity information. Communication between a peer and the network server as well as between peers is performed in a secure manner. Secure peer-to-peer session establishment involves mutual authentication and key agreement between peers, and results in shared session keys. Such keys can be subsequently delivered to third party applications for securing the communication between the corresponding users. Examples of such third party applications may include but are not limited to voice applications, video applications, messaging applications, and applications such as photo sharing and secure file sharing.

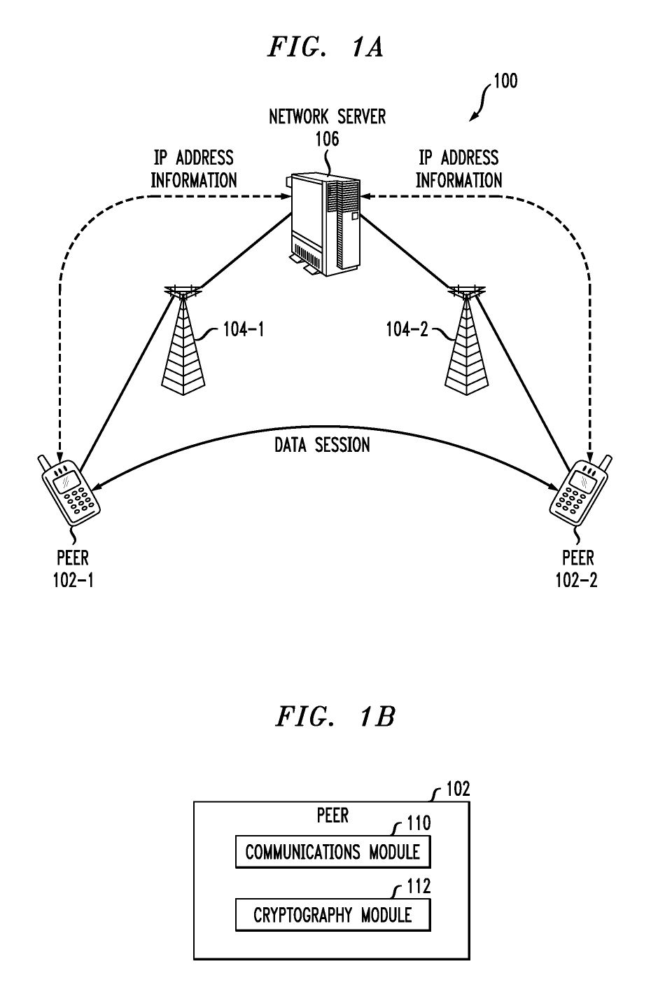

FIG. 1A illustrates a network-assisted peer-to-peer secure communication system, according to an embodiment of the invention. As shown, communication system 100 comprises a first peer 102-1, a second peer 102-2, a first base station 104-1, a second base station 104-2, and a network server 106. Note that the “communication system” refers to the overall system that includes the peers and the “communication network” to which the network server belongs (the communication network and network server are managed and maintained by a corresponding network operator).

Note also that the base stations 104-1 and 104-2 are typical access points that are used by the peers 102-1 and 102-2 to communicate with the network server 106 and with each other, and will not be further described.

Note further that only two peers are shown in FIG. 1A for the sake of simplicity of explanation, however, it is understood that the system 100 will typically have more than two peers. Also, the system 100 may comprise more than one network server, i.e., different groups of peers could communicate with different network servers, and the various network servers could pass connectivity information between themselves. Also, as mentioned above, a “network server” could comprise multiple server devices.

It is assumed that the system 100 has IP packet routing capability (or some form of packet forwarding capability at the link or network layer) and may comprise wireless and/or wireline links for passing packets.

The network server 106 maintains and disseminates connectivity information to registered peers. Upon peer registration, the server obtains connectivity information from the peer (e.g., its IP address) and provides connectivity information to the peer for fellow registered peers of interest. The network server provides mechanisms for mutual authentication and key agreement between the network server and each peer, as a part of peer registration.

It is assumed that peers 102-1 and 102-2 wish to establish end-to-end data connections and for this to occur, they need connectivity information, such as each other's IP address. Advantageously, each peer registers with the network server 106 in order to obtain such information for other peers of interest.

A peer may select a specific set of other peers for which connectivity information is needed (e.g., “friends”). Either the network server or a different server may handle the formation of groups-friends for each peer, upon peer registration. Such registration includes a procedure for mutual authentication and key agreement with the network server 106, in order for the peer to verify that connectivity information comes from an authenticated server. After obtaining connectivity information, a peer may contact another peer directly via a data session, i.e., without further assistance from the network server.

1. Peer Registration with the Network Server

The network server 106 provides connectivity information for reaching peers of interest. For this to occur, each peer needs to first register with the network server (assuming that an account already exists on the network server for the particular peer, i.e., we assume that the peer has bootstrapped with the network server beforehand). Registration with the network server may include a procedure for mutual authentication and key agreement, in order for the peer and the network server to verify each other's identity as well as for establishing a secure session, potentially over an inherently insecure network.

There are multiple different ways in which mutual authentication and key agreement may be performed. Examples include, but are not limited to: TLS (T. Dierks and E. Rescorla, “The Transport Layer Security (TLS) Protocol Version 1.2,” see IETF RFC 5246); AKA (J. Arkko et al., “Extensible Authentication Protocol for 3^{rd} Generation Authentication and Key Agreement (EAP-AKA)),” see IETF RFC 4187), PAK (see A. Brusilovsky et al., “Password-Authenticated Key (PAK) Diffie-Hellman Exchange,” see IETF RFC 5683); IBAKE (see V. Cakulev and G. Sundaram, “IBAKE: Identity-Based Authenticated Key Agreement,” IETF Internet-Draft, Apr. 20, 2011; and U.S. patent application Ser. No. 12/372,242, filed on Feb. 17, 2009, entitled “Identity Based Authenticated Key Agreement Protocol”), HTTP-Digest (see J. Franks et al., “HTTP Authentication: Basic and Digest Access Authentication,” see IETF RFC 2619), the disclosures of which are incorporated by reference in their entireties herein. Such methods assume either that the peer and the network server are pre-provisioned (or bootstrapped) with the same shared secret, and/or that they trust a third party which can issue credentials for them as well as potentially assist them in verifying each other's identities (such as a certification authority or a key management server).

### 2. Exchange of Connectivity Information

Upon successful registration, a peer (e.g., 102-1) and the network server 106 proceed with exchanging connectivity information, e.g., in this embodiment, IP address information. Other forms of connectivity information may include but are not limited to Visited IP address (if using Mobile IP), link layer identity (e.g., which RNC (Radio Network Controller) they are attached to in HSPA (High Speed Packet Access) or HRPD (High Rate Packet Data), which WLAN (Wireless Local Area Network) switch they are attached to in WiFi (Wireless Fidelity), or more generally layer 2 identity).

More specifically, the peer provides its connectivity information to the network server. This connectivity information is stored at the network server, and is available to other registered and authorized peers.

Each peer is typically associated with a specific group of fellow peers (friends, buddy lists), and this information is available to the network server. The list with the connectivity information of all affiliated online friends is provisioned to each registered peer in bulk, upon successful registration, preferably over the secured session that was established during peer registration (as discussed above). As soon as a peer obtains the list of IP addresses (for instance), it can independently initiate the end-to-end session establishment with any of its online friends (or initiate group communications involving more than one friend peer), using the corresponding IP address(es) in the obtained list.

a. Connectivity Information Distribution

There are multiple different methods with which connectivity information can be shared among peers through the network server, taking into account online/offline information as well as connectivity information updates (in one example, online means that a peer can be paged and responds, if not, the peer is offline). We provide some illustrative embodiments below. It is to be noted that while IP addresses are used as the example for describing connectivity information that is provided by the peers, embodiments of the invention are not limited thereto. As mentioned above, other forms of connectivity information may be employed.

(i) Pull method (initiated by the peer): With this method, the peer periodically polls the network server for updated information, while at the same time it provides its own information to the network server. Upon reception of a polling message (pulling), the networks server delivers the list of all online friends of the peer along with their corresponding IP addresses (which may be unicast as well as multicast). Such a peer-initiated polling typically takes place at periodic intervals, as well as potentially whenever the peer's IP address changes (and therefore the network server needs to be notified). Depending on the peer deployment dynamics, such a method may be overhead intensive in scenarios where peers remain static and online for a considerable amount of time. On the other hand, such overhead may be negligible when peers move constantly (potentially roam across different networks) and go online/offline frequently. Note also that if the pulling method (alone) is adopted, a peer is not informed about the online status of recently registered friends until the next scheduled pull message to the network server.

(ii) Push (initiated by the network server): The push method involves periodic messages by the network server to each registered peer. More specifically, upon peer registration, the network server stores the peer's IP address, and updates the IP address lists that need to be sent to each friend of the specific peer. Updated lists are sent in the upcoming periodic push message to each registered friend peer. Note that such periodic push may take place using a different frequency for different peers, based on the network server policy. This method is less network overhead intensive, since updates are only sent periodically, and not as soon as connectivity information is changed. Hence, if a peer goes online or offline (or if its IP address or connectivity information changes), such information will only be depicted in the next scheduled push message by the network server. On the other hand, if the IP address of a peer is changed before the next scheduled push message, then any attempts by a friend to reach that peer before the reception of the next push message will fail.

(iii) Hybrid: With the hybrid method, the networks server pushes information to each friend peer regarding online friends and their IP addresses, as soon as such information is updated. More specifically, the network server stores the last online friend list that was sent to each registered peer. Whenever a peer sends updated information, the network server compares the peer's information with the one that was sent to its friends during the last push message (similarly to the push method explained above). If the networks server identifies discrepancies, an updated push message is sent to all involved friends. The advantage with discrepancy checking is that the network server does not need to repeatedly send push messages to the peer's friends unless information about the peer has been changed. This may especially be the case in scenarios where the peer temporarily loses or resets its state. Note that such a push message may be sent every time a peer contacts the network server, i.e., without any discrepancy checking by the latter. In such a case however, the peer's friends may receive (obsolete) information which they already have. In addition to such a policy-based decision, the network server may also perform prediction algorithms to determine whether a peer is expected to remain online with a specific IP address for at least a specified (based on policy) time period, prior to informing the peer's friends with an updated push message.

b. Transport of Connectivity Information

Upon successful mutual authentication and key agreement between the peer and the network server, connectivity information is exchanged between them. Such information may be transported in multiple different ways such as, but not limited to, HTTP (R. Fielding et al., “Hypertext Transfer Protocol—HTTP/1.1,” see IETF RFC 2616), raw TCP (J. C. Snader, “Effective TCP/IP Programming: 44 Tips to Improve Your Network Programs,” Addison-Wesley Professional, ISBN-10: 9780201615890, May 2000), CoAP (Z. Shelby et al., Constrained Application Protocol (CoAP), see Draft-IETF-Core-CoAp-02), the disclosures of which are incorporated by reference in their entireties herein. Below we describe an embodiment where TCP sockets are used to facilitate such transport.

HTTP may be used in the classic client-server scheme, where the network server is an HTTP server, e.g. such as an APACHE server (see, e.g., Apache HTTP Server Project). Such a setting is especially applicable when the pull method is employed. With this method, the HTTP client (peer 102) periodically sends an HTTP request to the server (network server 106). The latter responds with the IP address list of the HTTP client's peer friends.

Peers may also exchange connectivity information via a network server that is implemented in a Representational State Transfer (REST) based approach (see, e.g., M. Hartl, “Ruby on Rails Tutorial,” and “Learn REST: A Tutorial,” the disclosure of which is incorporated by reference in its entirety herein). In such a case, the network server is designed in a REST-ful manner, offering resources to peers. Resources can be accessed and modified by peers using REST commands (such as READ, POST, CREATE, DELETE, etc.), upon successful peer authentication and authorization.

An embodiment based on REST may be implemented as follows. Upon successful registration with the network server, a peer is authorized to create a resource at the network server's REST-ful region using an HTTP-CREATE command, and further write (post) its IP address into the corresponding resource container, via an HTTP-POST command. The network server announces the creation of such a resource by the peer to all registered friend peers, via a REST announcement HTTP message. Each authorized friend peer may further access and read all the resources corresponding to all of its friends.

Various optimizations may be applied to such an embodiment. As an example, instead of having each peer access/read the resource containers of all of its friends, a resource mapping utility at the network server may map all the resources of interest for a particular peer to a new, single resource for that peer. Upon mapping, whenever a peer accesses the resource infrastructure of the network server, it only needs to read a single resource container, which contains the list with all the IP addresses of its friends (rather than having to read the corresponding resource container of each friend separately).

### 3. Peer De-Registration

In one embodiment, peers (102) may explicitly or implicit de-register from the network server (106).

With explicit de-registration, the peer sends a de-register message to the network server, with which the current registration and thereby the security association terminates, and all agreed key material during this registration are invalidated. Such de-registration may be initiated by the network server, if the latter wishes to de-register the peer.

With implicit de-registration, the network server invalidates the peer's current registration if the peer does not respond to the last push update message sent by the network server, after a pre-specified number of message retransmissions. Implicit de-registration may also take place based on other network server operator policies. For example, an active registration may automatically expire given that a specific time internal since registration activation has passed, or given that the peer has not contacted the network server for a specific, fixed period of time, which is also policy dependent.

Upon de-registration of a peer, the latter is treated as an offline peer. Peer's friends are notified either via any of the three methods (push, pull or hybrid) discussed above. Note that de-registration from the network server does not necessarily suggest that the peer is further un-reachable. The peer may still be reachable by other peers as long as there is a way for them to obtain connectivity information in order to reach the peer. As an example, after a peer de-registers, a friend may use the last known IP address to reach the peer. If such IP address is still valid and if the peer listens for end-to-end session requests, the session will still be established between the peers, although the network has stopped assisting such an establishment. This is because the network server only provides information to registered peers on how to reach each other. The network server is not involved in end-to-end data session establishment between the peers, before or after de-registration.

4. Establishment of p2p Session

After reception of connectivity information from the network server 106, a peer 102-1 may initiate an end-to-end data session set-up procedure with a friend peer 102-2. Various different data protocols may be used for such a session, depending on the type of traffic that will be exchanged between the peers. For example, RTP (H. Schulzrinne et al., “RTP Profile for Audio and Video Conferences with Minimal Control,” see IETF RFC 3551, the disclosure of which is incorporated by reference in its entirety herein) is a protocol that is typically preferred for end-to-end multimedia applications, involving audio and/or video traffic. On the other hand, FTP (P. Hethmon, “Extensions to FTP,” see IETF RFC 3659, the disclosure of which is incorporated by reference in its entirety herein) is a protocol that has been widely adopted for file transfer, and could be used. As mentioned above, the network server 106 is not involved in data session establishment between peers.

The establishment of data session between two or more peers may involve a security association establishment as a way to secure the exchange of end-to-end traffic. In particular, peers may mutually authenticate each other and agree on session key material that will be subsequently used to protect the exchanged data traffic. Such a secure session may be established as per different methods which can leverage symmetric or asymmetric cryptographic operations.

Symmetric methods rely on a shared secret pre-provisioned into each peer, which is used for mutual authentication and session key agreement. Protocols such as TLS-PSK (see the above-cited IETF RFC 5246) and PAK (see the above-cited IETF RFC 5683) may be used for this purpose.

Such a security association may alternatively be established using asymmetric cryptographic methods, such as IBAKE (see V. Cakulev and G. Sundaram, “IBAKE: Identity-Based Authenticated Key Agreement,” IETF Internet-Draft, Apr. 20, 2011; and U.S. patent application Ser. No. 12/372,242, filed on Feb. 17, 2009, entitled “Identity Based Authenticated Key Agreement Protocol,” the disclosures of which are incorporated by reference in their entireties herein) and MIKEY-IBAKE (see IETF RFC 6267, the disclosure of which is incorporated by reference in its entirety herein). Session keys that are agreed upon by such methods can be further utilized by secure data transfer protocols, such as SFTP (J. Galbraith, “SSH File Transfer Protocol,” see IETF Draft 2006) and SRTP (M. Baugher et al., “The Secure Real-time Transport Protocol (SRTP),” see IETF RFC 3711), the disclosures of which are incorporated by reference in their entireties herein. Note also that a variation of IBAKE can be utilized in the peer-to-peer context described herein when there is a group of participants. In such a case, security associations can be established in accordance with the conference IBAKE protocol described in U.S. patent application Ser. No. 12/549,907, filed on Aug. 23, 2010, entitled “Secure Key Management in Conferencing System,” the disclosure of which is incorporated by reference in its entirety herein.

Note that, while peers may be illustratively described herein as being mobile user devices such as smartphones, laptops or tablets, other devices (mobile or otherwise) can act as peers in the context of one or more of the illustrative embodiments described herein. By way of example only, in order to support inter-operability between systems (e.g., an LTE (Long Term Evolution) system with a PSTN (Public Switched Telephone Network) system), there is a need for specialized functions called media gateways which perform tasks such as transcoding. In such instances, a media gateway can act as a peer. As such, one or more illustrative embodiments of the invention are applicable to such media gateways.

5. p2p Architecture with IBAKE

In this section, we describe an illustrative embodiment of the inventive network-assisted p2p communication establishment framework. The example setting that we consider involves two peers, such as 102-1 and 102-2 in FIG. 1A, that wish to establish a secure multimedia session. For this to occur, each peer communicates with the network server 106 in order to obtain connectivity information, as well as with a KMS (key management server) in order to obtain security credentials that will be used for establishing an end-to-end security association. We use the above-cited IBAKE protocol for establishing such a security association between peers, upon provisioning each peer with an IBE private key.

More specifically, IBAKE is a protocol for mutual authentication and key agreement between two or more endpoints. It is based on a public-key based authentication mechanism, where each message is encrypted with the public key of the corresponding endpoint, as per the Identity Based Encryption (IBE) principles (X. Boyen et al., “Identity-Based Cryptography Standard (IBCS) #1: Supersingular Curve Implementations of the BF and BB1 Cryptosystems,” IETF RFC 5091, December 2007, the disclosure of which is incorporated by reference in its entirety herein).

As a result of the IBAKE protocol, a shared symmetric key is generated by each endpoint, which can further be used for securing the communication between the endpoints. IBAKE may be applied in a plurality of deployment scenarios that require the generation of a common symmetric key. Hence, IBAKE may be used, by way of example, for establishing end-to-end secure multimedia sessions between peers or, by way of further example, for mutually authenticating a peer with a server and deriving a common key. IBAKE offers multiple benefits in terms of facilitating a simplified public-key based mutual authentication and key agreement procedure, which does not depend on the existence of public key infrastructures and the incurred complexities thereof. IBAKE achieves secure mutual authentication between the participants, escrow-free key agreement, as well as perfect forward and backwards secrecy.

IBAKE has been proposed as a solution for media plane security (MEDIASEC) in IP Multimedia Subsystem (IMS) infrastructures (see 3GPP Technical Specification Group Services and System Aspects; IP Multimedia Subsystem (IMS); Stage 2 (Release 10), January 2011, the disclosure of which is incorporated by reference in its entirety herein). To that extent, IBAKE has been proposed in conjunction with a MIKEY-based transport solution, wherein SIP (Session Initiation Protocol) is leveraged in IMS in order to facilitate the IBAKE 3-way handshake protocol between two IMS clients, which are typically connected via a cellular access network infrastructure.

We now describe a design and implementation of a network-assisted p2p session set-up framework, according to one embodiment of the invention. The illustrative design comprises two main modules that reside in each peer: a communications module; and a cryptography (or crypto) module.

The communications module leverages client-server TCP/IP sockets in order to realize the peer-network server communication as well as the IBAKE three-way handshake. In addition, the communications module employs HTTP/TLS for communication between each peer and the key management server (KMS) for the secure provisioning of IBE private keys. The cryptography module performs all Elliptic Curve Cryptography (ECC) operations for IBAKE.

As will be explained below, each of these modules may further be structured as a combination of multiple other sub-modules, each of which implements one or more specific tasks. We assume the use of IBAKE for facilitating end-to-end secure multimedia session establishment. Within this context, we also describe how to implement IBAKE as an application layer utility, which can be executed over any access network technology, and which can establish end-to-end secure multimedia sessions between two or more IP-enabled mobile users—peers.

To illustrate this design, FIG. 1B shows main component modules of a peer. As shown, each peer 102 comprises a communications module 110 and a cryptography module 112. Note that, as will be explained below, the communications module 112 acts as a TCP client when the peer is an “initiator” of a p2p data session (e.g., peer 102-1 in FIG. 1A) and a TCP server when the peer is a “responder” to a p2p data session (e.g., peer 102-2 in FIG. 1A). We now describe the functions of the communications module and cryptography module. Note that the terms “initiator” and “responder” will be used periodically below to refer to a particular peer given its particular role in the data session.

a. Communications Module 110

In this illustrative embodiment, it is assumed that Internet TCP sockets are used for the communication between each peer and the network server, through which connectivity information is exchanged.

It is also assumed that HTTP/TLS is used in order to establish a secure session between an IBAKE peer and the key management server (KMS) for the purpose of delivering IBE private keys to the former. In this setting, the KMS is authenticated to the peer via a server-side certificate, while the peer is authenticated through HTTP-Digest, by using a login and a password. It is to be appreciated that other authentication and security association techniques are suitable as well.

It is further assumed Internet TCP sockets are used for carrying the IBAKE messages between peers, i.e., for realizing the communication between the IBAKE initiator (e.g., peer 102-1) and the IBAKE responder (e.g., peer 102-2). TCP sockets are described in detail in M. J. Donahoo et al., “TCP/IP Sockets in C: Practical Guide for Programmers,” Second Edition, ISBN-10: 0-12-374540-3, 2009, and in J. C. Snader, “Effective TCP/IP Programming: 44 Tips to Improve Your Network Programs,” Addison-Wesley Professional, ISBN-10: 9780201615890, May 2000, the disclosures of which are incorporated by reference in their entireties herein.

In the context of the IBAKE protocol, the initiator is supposed to initially contact the responder in a peer-to-peer fashion. For this to occur, the responder has to be at a state where it is possible to accept and to serve requests for establishing IBAKE sessions. Hence, the responder can be considered as a TCP socket server, which (in the idle mode) waits for the initiator to start the IBAKE protocol. Similarly, the initiator can be realized as a TCP socket client, which establishes a TCP session with the responder's TCP socket server, and further sends the first IBAKE message to the latter. Note, however, that in order for the initiator to communicate with the responder using TCP sockets, the IP address of the latter has to be known to the former. For this to occur, an application layer utility is employed, wherein the network server can inform the IBAKE participants of each other's IP address, as described above.

Given this, the communications module 110 performs the following four main tasks: (i) communication between an IBAKE peer and the network server; (ii) secure session establishment with the KMS; (iii) TCP session establishment between initiator and responder; and (iv) IBAKE three-way handshake protocol.

(i) Communication Between IBAKE Peer(s) and the Network Server

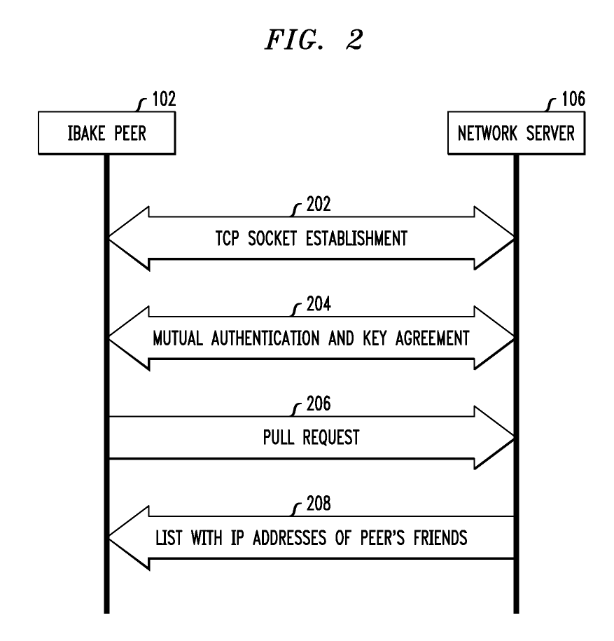

FIG. 2 illustrates communication between an IBAKE peer and network server. FIG. 2 illustrates a communication protocol between a peer and a network server, according to an embodiment of the invention. Each IBAKE peer 102 (in this scenario, the initiator and the responder) periodically polls the network server 106 in order to receive the most up-to-date information regarding the IP addresses of other peers. This is the pull method described above in section 2a. As alternative methods, either a push or a hybrid method may be followed, as also described above in section 2a.

Communication between the peer 102 and the network server 106 is realized via Internet TCP socket approach, which is established in exchange 202 shown in FIG. 2. More specifically, the peers (IBAKE initiator and responder) independently initiate the establishment of a TCP socket connection to the network server, using the latter's publicly known IP address. The network server accepts the individual socket establishment requests.

In exchange 204, each peer mutually authenticates with the network server. In one embodiment, this can be done using a challenge handshake authentication protocol (CHAP) as described in U.S. Pat. No. 7,904,715 issued on Mar. 8, 2011 in the name of S. Mizikovsky, the disclosure of which is incorporated by reference in its entirety herein. It is realized, however, that various other authentication protocols, such as TLS-PSK, may be alternatively used. Using CHAP in this inventive context, a pre-provisioned key is used at both the network server and the peer. The CHAP payload is carried over the previously established TCP socket session. Successful authentication using CHAP is followed by agreement of a shared session key, which can further be used, if so desired, for securing the session between peer and the network server.

Upon successful mutual authentication and key agreement, in step 206, the IBAKE initiator sends a pull request to the network server. The latter uses the TCP socket to send the full list with the currently online friends of the IBAKE initiator along with their IP addresses, in step 208. With this, the IBAKE initiator becomes aware of the IP address of its responder and can further use this IP address for requesting a TCP session establishment.

(ii) Secure Session Establishment with the KMS

In order to decrypt IBAKE messages, the initiator and the responder have to obtain IBE private keys from a Key Management Server (KMS). Private keys are transported securely so that only the peer with the corresponding public identity is able to obtain them. Such a secure TLS session may be established using certificates, or pre-shared secrets or a combination thereof.

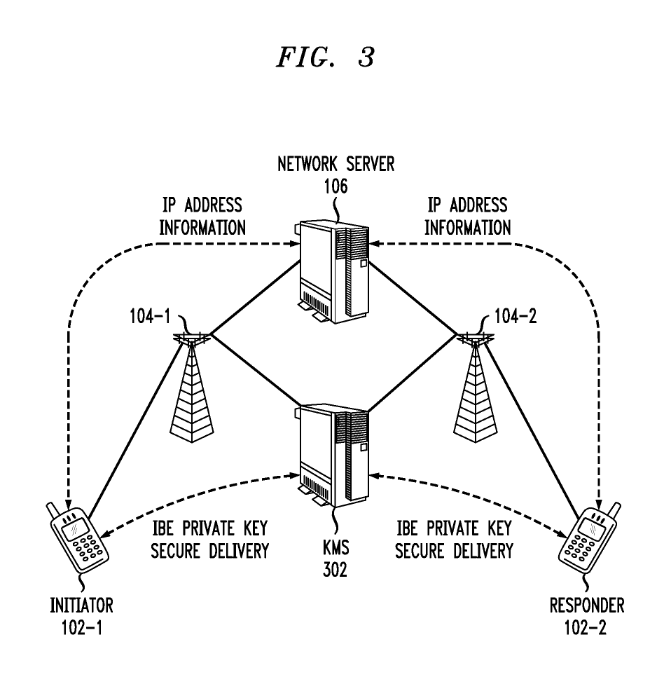

FIG. 3 shows this part of the inventive framework for the case where the IBAKE initiator and the IBAKE responder are two mobile cellular users (i.e., peers 102-1 and 102-2). The network server 106 and the KMS 302 are both contacted via the wireless access network. Alternatively, access to these servers may be facilitated through the use of other wireless interfaces on the device, such as WiFi/WLAN, WiMax, ZigBee, Bluetooth, etc., as well as potentially wireline interfaces in scenarios where such devices are equipped with such interfaces (e.g. Ethernet, FireWire, etc.).

(iii) TCP Session Establishment Between Initiator and Responder

The responder is constantly running a TCP server process (i.e., part of communication module 110 in FIG. 1B) on a specific port, which waits (“listens”) for TCP establishment requests from clients. The initiator executes a TCP client process (i.e., part of communication module 110 in FIG. 1B). Upon initiation, this process takes the TCP server's IP address and port as inputs (in fact, the port may be fixed and hence it may be apriori known to the client), and further requests a TCP socket establishment with the responder. The responder (TCP server) accepts the request. Upon acceptance, the TCP server initializes a new socket descriptor, which is further used for the subsequent data exchange between initiator and responder. At this point, the TCP session between initiator and responder has been established and, hence, the initiator may proceed with the transmission of the first IBAKE message over TCP.

(iv) IBAKE 3-Way Handshake

As described in the above-referenced U.S. patent application Ser. No. 12/372,242, IBAKE messages are intended to exchange “random key components” on an elliptic curve, that allow for mutual authentication and session key agreement. In the first message (IBAKE message 1 or first IBAKE message), the initiator sends a random key component to the responder, encrypted using the responder's public key. The responder then decrypts this message using a private key (and observe that only the responder who has the private key can decrypt), chooses a new random key component and sends the received key component and the new key component back to the initiator. This second message (IBAKE message 2 or second IBAKE message) is encrypted by the responder using the initiator's public key. The initiator will then decrypt this message and be able to authenticate the responder and calculate the session key. The third message (IBAKE message 3 or third IBAKE message) is an encryption of the responder's key component sent in the second message, and is intended for the responder to authenticate the initiator. In this manner, both initiator and responder mutually authenticate each other and calculate a session key.

By way of example, suppose A, B are the two entities (or parties, where A represents a computing device of a first party and B represents a computing device of a second party) that are attempting to authenticate and agree on a key. More particularly, assume that A and B represent corresponding identities of two computing devices that wish to communicate, which by definition also represent their public keys.

Let H₁(A)=Q_{A} and H₁(B)=Q_{B} be the respective points on the elliptic curve corresponding to the public keys. In effect, one could refer to Q_{A} and Q_{B} as the public keys as well, since there is a one-to-one correspondence between the identities and the points on the curve obtained by applying H₁.

Let x be a random number chosen by A, and let y be a random number chosen by B.

A computes xP (i.e., P added to itself x times as a point on E, using the addition law on E) encrypts it using B's public key, and transmits it to B. In this step, encryption refers to identity based encryption IBE described in D. Boneh et al., “Identity-Based Encryption from the Weil Pairing” Advances in Cryptology—Proceedings of CRYPTO 2001 (2001), the disclosure of which is incorporated by reference in its entirety herein. Note that P is a point of large prime order.

Upon receipt of the encrypted message, B decrypts the message and obtains xP. Subsequently B computes yP, and encrypts the pair {xP, yP} using A's public key and then transmits it to A.

Upon receipt of this message, A decrypts the message and obtains yP. Subsequently, A encrypts yP using B's public key and sends it back to B.

Following this, both A and B compute xyP as the session key.

Observe that A chose x randomly, and received yP in the second step of the protocol exchange. This allows A to compute xyP by adding yP to itself x times. Conversely, B chose y randomly, and received xP in the first step of the protocol exchange. This allows B to compute xyP by adding xP to itself y times. Note also that x is random but xP provides no information about x. Therefore, xP is a component of a key based on a random secret chosen by A. Likewise, y is random but yP provides no information about y. Hence, yP is a component of a key based on a random secret known only to B. Advantageously, xyP can serve as a session key.

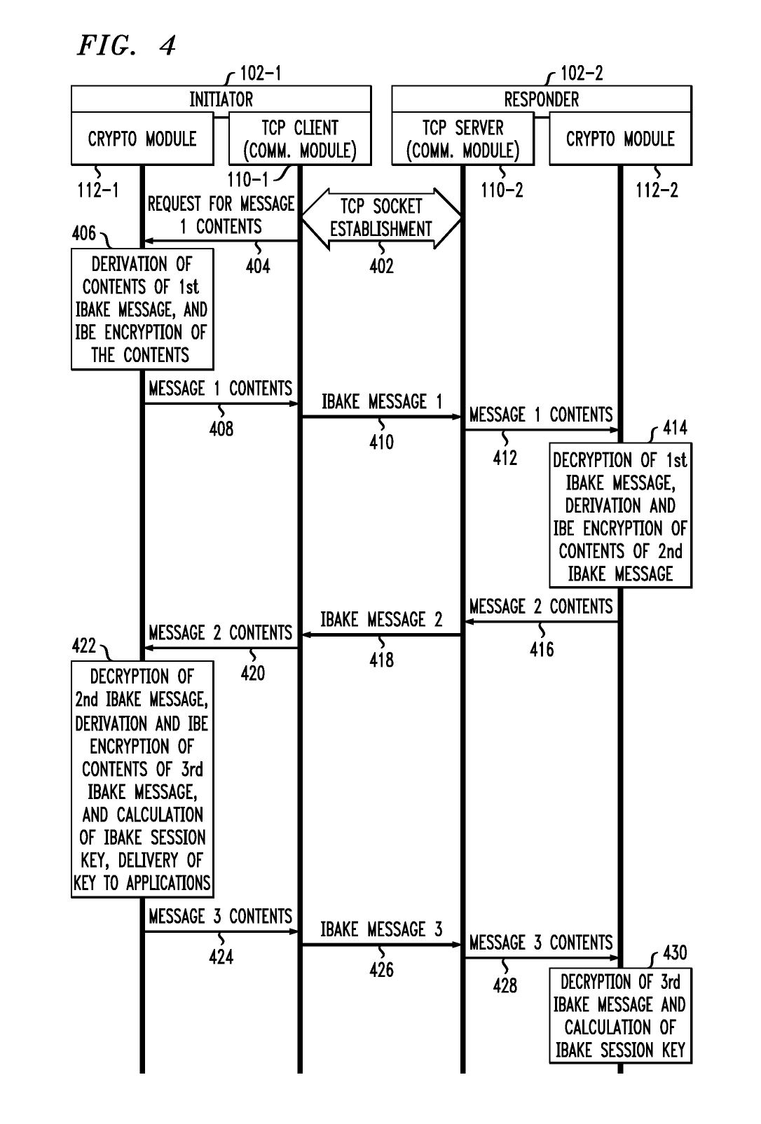

With this general understanding of the IBAKE protocol, FIG. 4 shows the IBAKE exchange between the initiator (e.g., 102-1 in FIG. 1A) and the responder (e.g., 102-2 in FIG. 1A). It is assumed that a TCP socket has been established between the initiator and responder in exchange 402. Thus, the communication module 110-1 of peer 102-1 (initiator) operates as a TCP client, while the communication module 110-2 of peer 102-2 (responder) operates as a TCP server. Also, as shown, peer 102-1 has a crypto module 112-1 and peer 102-2 has a crypto module 112-2.

In step 404, communications module 110-1 requests content for the first IBAKE message (message 1).

In step 406, the crypto module 112-1 derives the content of the first IBAKE message and encrypts the content using IBE encryption.

In step 408, the crypto module 112-1 sends the encrypted content to the communications module 110-1. In one embodiment, the communications module 110-1 obtains the contents of the first IBAKE message from the crypto module 112-1 in the form of a file (or a set of files). The file contents are read by the communications module 110-1 and are written into the TCP socket, in step 410, which constitutes IBAKE message 1. For this step, the corresponding socket descriptor is used as a reference, which was instantiated during the TCP session establishment phase (402). Depending on the overall size of the contents as well as on design preferences regarding code modularity and scalability, multiple TCP socket write operations may be performed in a sequential manner, as long as the TCP server (responder) is implemented accordingly (i.e., as long as it knows how many corresponding read operations need to be performed in order to receive the contents of each IBAKE message).

Upon reception of the first IBAKE message, the communications module 110-2 (TCP server) of the responder 102-2 delivers, in step 412, the message contents to its crypto module 112-2 for further processing.

In step 414, the crypto module 112-2 decrypts the first IBAKE message, and generates and IBE-encrypts the contents (again, in the form of one or more files) for the second IBAKE message. This content is provided to the communications module 110-2 in step 416.

The communications module 110-2 (TCP server) writes the file contents into the TCP socket in step 418 (shown as IBAKE message 2) using the socket descriptor that was initialized upon acceptance of the TCP session establishment request by the client.

Similarly, at the initiator (client) side, the contents of message 2 are received by the communications module 110-1 (TCP client) and are delivered to the initiator's crypto module 112-1, in step 420, for IBE decryption and further processing in step 422. That is, in step 422, the crypto module 112-1 decrypts the second IBAKE message, derives and IBE-encrypts the contents of the third IBAKE message. The crypto module 112-1 also calculates the IBAKE session key.

In step 424, the crypto module 112-1 provides the third IBAKE message content to the communications module 110-1, and the communications module 110-1 sends the third IBAKE message to the communications module 110-2 of the responder in step 426.

In step 428, the communications module 110-2 delivers the message to its crypto module 112-2. The crypto module 112-2 decrypts the message and generates, in step 430, the same IBAKE session key that the initiator generated (in step 422).

Thus, at the end of this message exchange, the initiator and the responder have calculated the same IBAKE session key, which they further deliver to one or more third party applications for securing the subsequent communication (e.g., voice or video call, etc.).

Note that, in the protocol of FIG. 4, a request for content sent from a communication module of a peer to its crypto module may be realized in the form of system calls. For example, in order to obtain the contents of the first IBAKE message, the TCP client may perform a system call thereby calling a cryptography module script, which generates a RAND value, computes a RAND*P value and finally IBE-encrypts this value along with the initiator's and responder's identities with the public key of the latter.

Note that RAND is a random value serving the same purpose as x (for party A in general IBAKE example above) or y (for party B in general IBAKE example above). That is, the initiator randomly chooses RANDᵢₙᵢₜᵢₐₜₒᵣ and the responder randomly chooses RAND_{responder}.

Note also that in FIG. 4, the communication of the TCP client/server with the local cryptography module is preferably internal, and may be realized in various ways, e.g., via inter-process communication through internal sockets, or by calling the corresponding local crypto modules from within the TCP client and server respectively (through a system call or by linking them with the client/server code and referring to the appropriate libraries).

In a preferred embodiment, we have chosen the system call approach, where upon reception of an IBAKE message, the contents of the message are extracted, they are written into one or more files, and subsequently the crypto module is called through a system call. This is advantageous in that the TCP client and server code is completely independent and unlinked from the cryptographic operations of IBAKE. With this, the IBAKE code may be directly re-used with other networking solutions, i.e., it is not bound to the specific client-server socket implementation.

It is to be understood, however, that the choice of correlating the TCP socket code (or any code that realizes communication between initiator and responder) with the cryptography code is not directly related to the generic implementation shown in FIG. 4, since such a design may accommodate any development style.

b. Cryptography Module 112

The cryptography module 112 is responsible for performing the cryptographic operations that are related to IBAKE, i.e.: (a) the IBE encryption and decryption; (b) the calculation of RAND*P (where RAND is a random number chosen independently by initiator and responder while P is a known point on the chosen elliptic curve); (c) the mutual authentication process, where initiator and responder validate the authenticity of each other; and (d) the calculation of the IBAKE session key (i.e., the point RAND_{Initiator}*RAND_{Responder}*P and the corresponding symmetric key).

While mutual authentication takes place by simply comparing the transmitted and received values of RAND*P, the rest of the above operations are Elliptic Curve Cryptography (ECC) operations. For the purposes of calculating RAND*P values, NIST (National Institute of Standards and Technology) has approved certain types of elliptic curves (such as Koblitz curves). Typically 163-bit Koblitz curves (approved by NIST) are preferable for such purposes. Note that while to date NIST has not suggested any types of curves for IBE operations, typically 768-bit or 1024-bit non-supersingular curves are preferable. Various different ECC libraries have been developed in the past and are publicly available (e.g., The Pairing Based Cryptography (PBC) Library, and Multiprecision Integer and Rational Arithmetic C/C++ Library).

In what follows, we describe embodiments of the cryptography module for the initiator and the responder. We first describe cryptography module operations for the initiator and then the responder.

(i) Initiator's Cryptography Module Operations

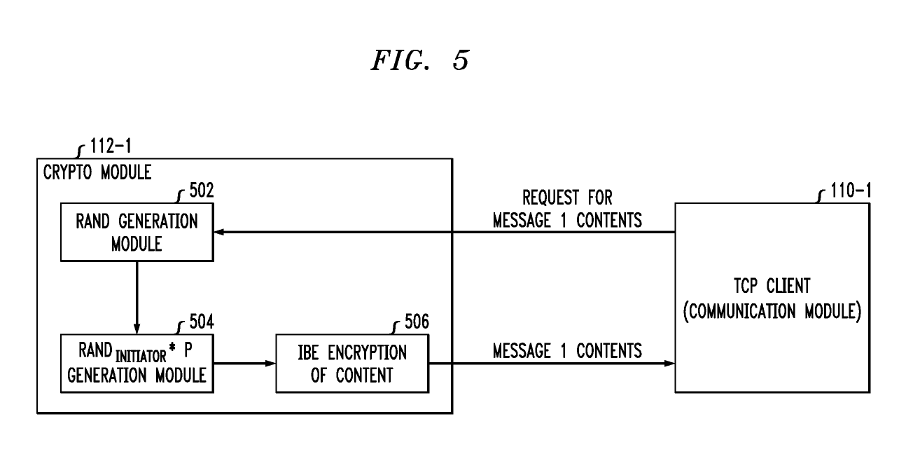

The crypto module 112-1 resides in the initiator's mobile device (e.g., peer 102-1). FIG. 5 shows the tasks performed by the crypto module in preparing the first IBAKE message.

The crypto module 112-1 obtains the IBE private key that matches the IBE public key in use. If the initiator obtains a list of keys from the KMS, the crypto module parses this list and extracts the appropriate private key. In addition, the crypto module identifies the full public identity of both the initiator and the responder.

The crypto module 112-1 also generates the IBAKE content by calculating a random number, RANDᵢₙᵢₜᵢₐₜₒᵣ, in sub-module 502, and further calculating the value of RAND_{Initiator}*P, in sub-module 504, in terms of coordinates on the chosen Koblitz elliptic curve. The sub-modules can communicate through system calls.

The crypto module 112-1 also IBE-encrypts the RAND_{Initiator}*P along with the public keys of the initiator and responder, in sub-module 506, and writes the encrypted content in a file. Similarly here, the IBE encryption sub-module 506 is reached through a system call. The contents that are to be encrypted are provided in the form of a file. The encrypted data is stored in a file, which is provided to the TCP client (communications module 110-1).

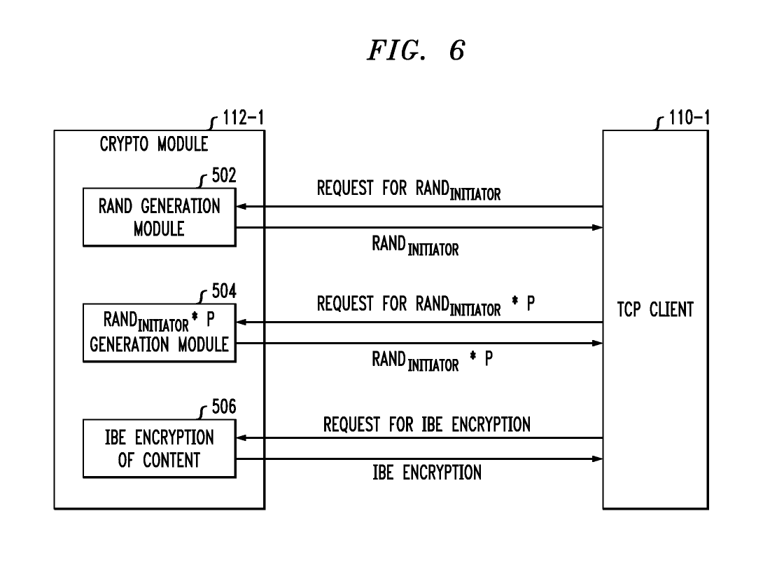

An alternative implementation approach could involve the application of direct system calls from the TCP client to each sub-module of the crypto module, as shown in FIG. 6. The advantage of such an approach would be that the TCP client would be in control of the inputs and the outputs of each sub-module. Also, a hybrid implementation approach involving both methods (of FIGS. 5 and 6) is also viable.

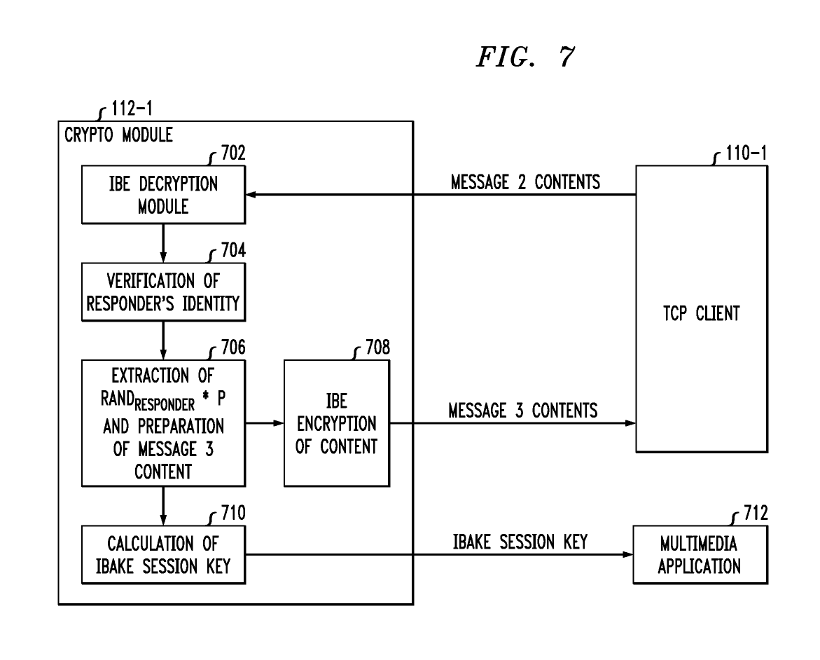

As soon as the TCP client receives the second IBAKE message from the TCP server, it delivers the message contents to the initiator's crypto module 112-1. The operations of the crypto module upon receiving the second IBAKE message are depicted in FIG. 7.

As shown, the crypto module 112-1 performs a system call to the IBE decryption sub-module 702, providing the encrypted contents of message 2 along with the initiator's IBE private key. The IBE decryption sub-module 702 uses the private key to decrypt the input data, and further stores the decrypted content into a file. The file hence contains the decrypted RAND_{Responder}*P value, as well as the decrypted public identities of the initiator and the responder.

The decrypted data that was included in the second IBAKE message allows the initiator to verify the responder's identity by comparing the originally computed value of RANDᵢₙᵢₜᵢₐₜₒᵣ*P with the one returned in the second message. This authentication is performed by sub-module 704.

In sub-module 706, the value of RAND_{Responder}*P is extracted from the second IBAKE message and the content of the third IBAKE message is generated. This content is IBE-encrypted in sub-module 708, which then sends the content to the TCP client.

At this point, via sub-module 710, the crypto module uses the values of RANDᵢₙᵢₜᵢₐₜₒᵣ*P and RAND_{Responder}*P in order to calculate the IBAKE session key, i.e., the key that corresponds to the point RAND_{Initiator}*RAND_{Responder}*P on the chosen Koblitz curve. The calculation may be performed by the same sub-module that performed the calculation of RANDᵢₙᵢₜᵢₐₜₒᵣ*P, which is initiated via a similar system call as explained above.

The IBAKE session key (or a derivative of it) is further provided to multimedia applications 712 that can use it for encrypting and/or integrity protecting multimedia content in an end-to-end manner. The key is delivered in the form of a file. While protecting all the key material in the mobile device is beyond the scope of this description, care should be taken within the premises of the mobile operating system in order to protect the keys from being obtained by unauthorized applications. Note here that the delivery of the key may be delayed until the reception of a positive acknowledgment from the responder regarding the result of the initiator's identity verification.

(ii) Responder's Cryptography Module Operations

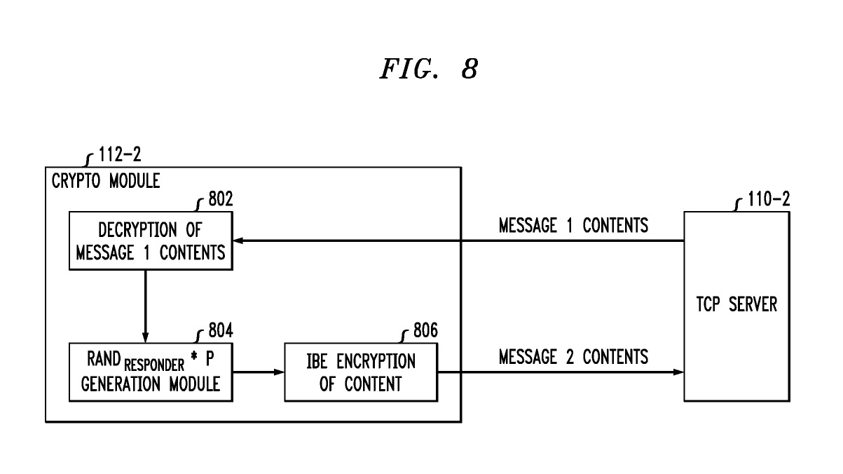

The responder's crypto module 112-2 performs the same set of ECC operations upon reception of the first and the third IBAKE messages. More specifically, upon reception of the first IBAKE message, the module performs the operations shown in FIG. 8.

The crypto module 112-2 obtains the one IBE private key that matches its currently valid IBE public key. If the responder obtains a list of keys from the KMS, the crypto module parses this list and extracts the appropriate private key. In addition, the crypto module identifies the full public identity of both the initiator and the responder.

As shown in FIG. 8, the crypto module 112-2 performs a system call to the IBE decryption sub-module 802, providing the encrypted contents of message 1 along with the responder's IBE private key. The IBE decryption sub-module 802 uses the private key to decrypt the input data, and further stores the decrypted content into a file. The file thus contains the decrypted RANDᵢₙᵢₜᵢₐₜₒᵣ*P value, as well as the decrypted public identities of the initiator and the responder.

Similar to the initiator for IBAKE message 1, the crypto module 112-2 of the responder, in sub-module 804, generates a random number (RAND_{Responder}) and further calculates the value of RAND_{Responder}*P in terms of coordinates on the chosen Koblitz elliptic curve. The sub-modules can communicate through system calls.

The crypto module 112-2 IBE-encrypts the RAND_{Responder}*P along with the public keys of the initiator and the responder, via sub-module 806, and writes the encrypted content in a file. Similarly, the IBE encryption sub-module 806 is reached through a system call. The contents that are to be encrypted are provided in the form of a file. The encrypted data is stored in a file, which is provided to the TCP server (communications module 110-2). The TCP server further transmits IBAKE message 2 to the TCP client (communications module 110-1) as a response.

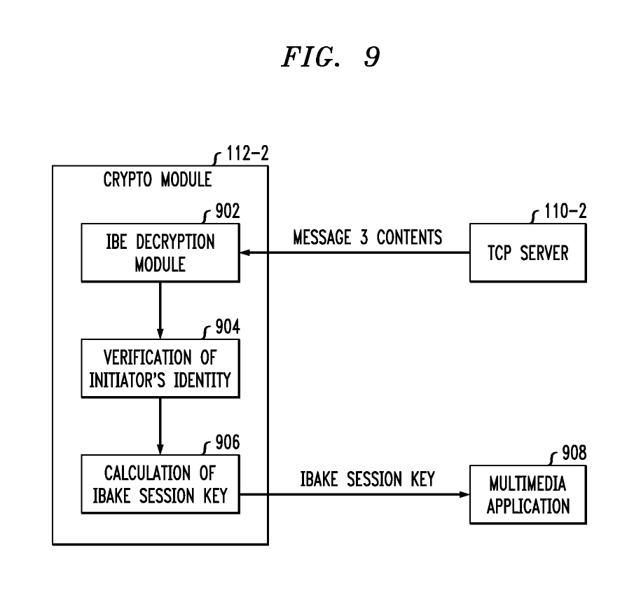

As soon as the responder receives IBAKE message 3, it decrypts the message contents and further verifies the identity of the initiator. More specifically, upon reception of the third IBAKE message, the following tasks are performed by the responder's crypto module 112-2, as depicted in FIG. 9.

The TCP server performs a system call to the IBE decryption sub-module 902, providing the encrypted contents of IBAKE message 3. The IBE decryption sub-module 902 uses the responder's IBE private key to decrypt the input data, and further stores the decrypted content into a file.

The decrypted data that was included in the third IBAKE message allows the responder to verify the initiator's identity by comparing the originally computed value of RAND_{Responder}*P with the one returned in the third IBAKE message. This is done in sub-module 904.

At this point, sub-module 906 uses the values of RANDᵢₙᵢₜᵢₐₜₒᵣ*P and RAND_{Responder}*P in order to calculate the IBAKE session key, i.e., the key that corresponds to the point RANDᵢₙᵢₜᵢₐₜₒᵣ*RAND_{Responder}*P on the chosen Koblitz curve. The calculation may be performed by the same sub-module that performed the calculation of RANDᵢₙᵢₜᵢₐₜₒᵣ*P, which is initiated via a similar system call as described above.

The IBAKE session key (or a derivative of it) is further provided to multimedia applications 908 that can use it for encrypting and/or integrity protecting multimedia content in an end-to-end manner.

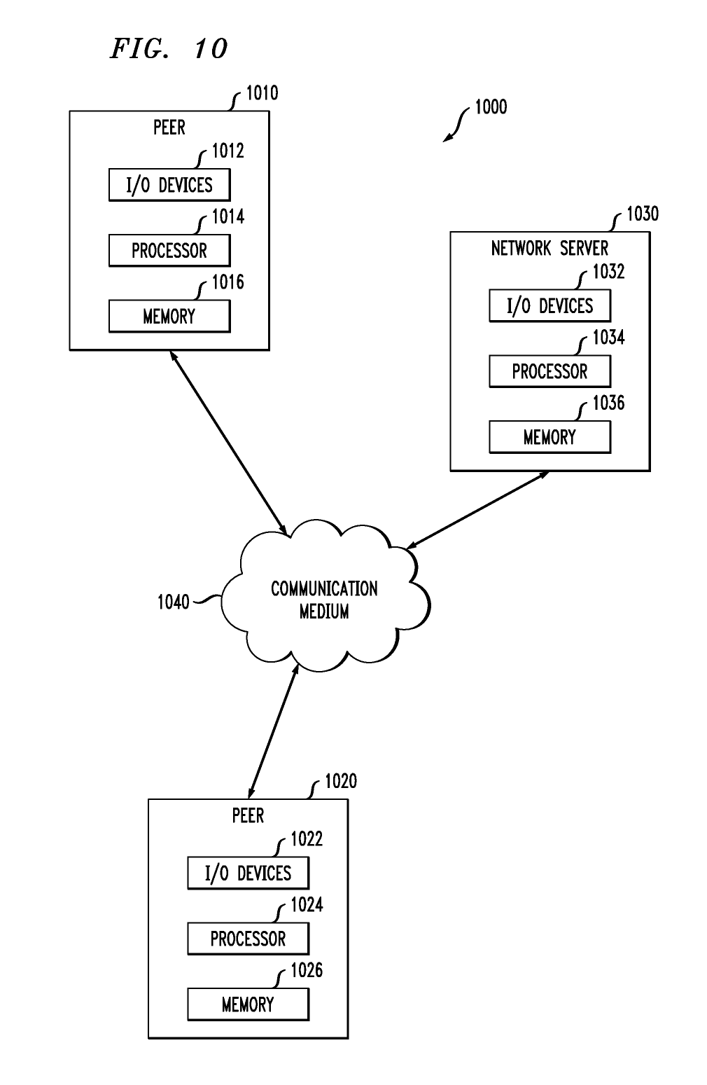

Lastly, FIG. 10 illustrates a generalized hardware architecture of a part of a communication system 1000 suitable for implementing network-assisted p2p secure communications according to the above-described principles of the invention.

As shown, computing device (peer) 1010 (corresponding to peer 102-1), computing device 1020 (corresponding to peer 102-2), and network server 1030 (corresponding to network server 106) are operatively coupled via communication medium 1040. The network medium may be any network medium across which the peers and the network server are configured to communicate. By way of example, the network medium can carry IP packets and may involve any of the communication networks mentioned above. However, the invention is not limited to a particular type of network medium.

As would be readily apparent to one of ordinary skill in the art, the elements may be implemented as programmed computers operating under control of computer program code. The computer program code would be stored in a computer (or processor) readable storage medium (e.g., a memory) and the code would be executed by a processor of the computer. Given this disclosure of the invention, one skilled in the art could readily produce appropriate computer program code in order to implement the protocols described herein.

Nonetheless, FIG. 10 generally illustrates an exemplary architecture for each device communicating over the communication medium. As shown, peer 1010 comprises I/O devices 1012, processor 1014, and memory 1016. Peer 1020 comprises I/O devices 1022, processor 1024, and memory 1026. Network server 1030 comprises I/O devices 1032, processor 1034, and memory 1036.

It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM). In addition, the term “I/O devices” as used herein is intended to include one or more input devices (e.g., keyboard, mouse) for inputting data to the processing unit, as well as one or more output devices (e.g., CRT display) for providing results associated with the processing unit.

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU. Such memory devices may each be considered a computer readable storage medium or a non-transitory storage medium. Each device (1010, 1020, and 1030) shown in FIG. 10 may be individually programmed to perform their respective steps of the protocols and functions depicted in FIGS. 1 through 9. Also, it is to be understood that each of block 1010, block 1020, and block 1030 may each be implemented via more than one discrete node or computing device.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for secure communications, comprising:
providing, by a first computing device, connectivity information associated therewith to a network server;
receiving, at the first computing device, connectivity information respectively associated with one or more other computing devices from the network server;
establishing, by the first computing device and independent of the network server, a security association with at least one of the one or more other computing devices; and
participating, by the first computing device and independent of the network server, in a secure peer-to-peer session with the at least one other computing device.

2. The method of claim 1, further comprising requesting, by the first computing device, the connectivity information respectively associated with the one or more other computing devices from the network server.

3. The method of claim 1, further comprising periodically receiving, at the first computing device, the connectivity information respectively associated with the one or more other computing devices from the network server.

4. The method of claim 1, further comprising receiving, at the first computing device, the connectivity information respectively associated with the one or more other computing devices from the network server following receipt of updated connectivity information from at least one of the one or more other computing devices at the network server.

5. The method of claim 1, wherein the step of receiving, at the first computing device, the connectivity information respectively associated with one or more other computing devices from the network server further comprises reading, by the first computing device, one or more resource containers residing at the network server.

6. The method of claim 1, further comprising establishing, by the first computing device, a security association with the network server prior to providing its connectivity information to the network server.

7. The method of claim 1, further comprising registering, by the first computing device, with the network server prior to the first computing device providing its connectivity information to the network server.

8. The method of claim 7, further comprising de-registering the first computing device with the network server.

9. The method of claim 8, further comprising sending, by the first computing device, a de-register message to the network server.

10. The method of claim 8, further comprising receiving, at the first computing device, a de-register message from the network server.

11. The method of claim 8, wherein the registration of the first computing device is invalidated based on one or more de-registration criteria.

12. The method of claim 11, wherein the one or more de-registration criteria comprise at least one of an existence of a non-responsive condition on the part of the first computing device and an expiration condition associated with a registration time period.

13. The method of claim 1, wherein the step of establishing, by the first computing device, the security association with the at least one other computing device is performed in accordance with an identity based authenticated key exchange protocol.

14. The method of claim 13, wherein, during the establishment of the security association between the first computing device and the at least one other computing device, a session key is agreed upon for use in the secure peer-to-peer session.

15. The method of claim 1, wherein the network server comprises a single server device or multiple server devices.

16. The method of claim 15, wherein, when the network server comprises multiple server devices, different ones of the multiple server devices perform different operations with respect to the first computing device and the one or more other computing devices.

17. A computing device, comprising:
a memory; and
a processor device operatively coupled to the memory and configured to cause the computing device to:
provide connectivity information associated with the computing device to a network server;
receive from the network server connectivity information respectively associated with one or more other computing devices;
establish, independent of the network server, a security association with at least one of the one or more other computing devices; and
participate, independent of the network server, in a secure peer-to-peer session with the at least one other computing device.

18. A system, comprising:
a communications module; and
a cryptography module operatively coupled to the communications module;
wherein the communications module and the cryptography module cooperate to perform the steps of:
providing connectivity information to a network server;
receiving from the network server connectivity information respectively associated with one or more computing devices;
establishing, independent of the network server, a security association with at least one of the one or more computing devices; and
participating, independent of the network server, in a secure peer-to-peer session with the at least one computing device.

19. The system of claim 18, wherein the communications module is configured to operate as a client when initiating the secure peer-to-peer session.

20. The system of claim 18, wherein the communications module is configured to operate as a server when responding to initiation of the secure peer-to-peer session by at least one of the one or more computing devices.
